(19) United States
(12) Patent Application Publication
(10) Pub. No.: US 2022/0063884 A1
(43) Pub. Date: Mar. 3, 2022

(54) Apparatus and a Method of Sensitive Consumables Goods Container and Delivery System

(71) Applicant: Seth Howard, Pearland, TX (US)

(72) Inventor: Seth Howard, Pearland, TX (US)

(21) Appl. No.: 17/458,042

(22) Filed: Aug. 26, 2021

Related U.S. Application Data
(60) Provisional application No. 63/070,276, filed on Aug. 26, 2020.

(51) Int. Cl. B65D 55/02; B65D 5/56; B65D 25/14; B65D 81/24; B65D 5/46; B65B 5/04

(52) U.S. Cl. CPC B65D 55/02; B65D 5/563; B65B 5/04; B65D 81/24; B65D 5/46128; B65D 25/14

(57) ABSTRACT

The invention provides for a sensitive consumable goods delivery system that consisting of an container having antibacterial and antimicrobial properties, wherein the container is locked once the goods are placed therein. The delivery can be tracked via a barcode on the locking mechanism placed on the container.

### CROSS-REFERENCE TO RELATED APPLICATIONS

This application the benefit U.S. Provisional Application No. 63/070,267, filed Aug. 26, 2021.

### FIELD OF THE INVENTION

The present invention relates to an apparatus and method of sensitive consumable goods delivery. Specifically, the invention relates to an apparatus and a method of sensitive consumable goods delivery comprising an antibacterial and antimicrobial take-out container.

### BACKGROUND

Antibacterial and antimicrobial packaging is of increasing importance in the sensitive consumable goods industry. Antibacterial and antimicrobial packaging allows sensitive consumable goods delivery services to distribute the goods secure, and safely to the patrons. Antibacterial and antimicrobial packaging also enables both the merchant and the consumer to decrease contamination of the product. This permits all parties to ensure the safe delivery of sensitive consumables, like food and medical products, especially when safety is essential.

Consumable goods (e.g., food and sensitive products) can be ordered utilizing applications on mobile devices. When the mobile user requests delivery of their ordered goods using a service, this type of service delivery introduces multiple points of contact from the time the goods are prepared and packaged to the time when the goods are delivered to their final destination. For example, the possibility of contamination exists for a food delivery due to transferring contact of the food packaging from the point of order to the delivery person.

The need exists for consumers to order sensitive consumable goods from the convenience of their mobile device, to ensure that the goods are free of contamination and is accurately delivered.

### SUMMARY OF THE INVENTION

The main objective of the present invention is to provide a secure, traceable and contamination free delivery for sensitive consumables goods. Once the goods have been placed within the container a lock will be placed on the container sealing in the goods. The lock contains a barcode which can be scanned and used to identify the person who placed the order and the location the order is to be delivered.

The barcode is used (e.g., scanned) by both the delivery driver and the patron who order the goods to ensure the right order has been delivered to proper patron using a mobile device application, and that the container has not been opened since the sensitive consumable goods was first placed therein.

In some embodiments, the container is a packaging, such as a foldable cardboard sheet or a plastic bag with antibacterial and antimicrobial compounds on its surface which forms a container that can be used to deliver sensitive consumable goods to the ordering consumer. In some embodiments, the lock is used to seal the container is in communication with a mobile application, which can be used to monitor the location of the container.

The mobile application is a application software designed to run on a mobile device, such as a smartphone or tablet computer, which can be used to ensure that the container is delivered to the right person, the container's physical location, and the estimated time of delivery. The application can provide other parameters set by the merchant or the consumer in different languages to aid in bridging language barriers, different phone manufactures, and computer software. This is especially helpful to ensure that product/goods tampering does not occur by third-party delivery persons and services responsible for making the delivery.

Other objects, features and advantages of the present invention will become apparent from the following detailed description when taken in conjunction with the accompanying drawings.

### BRIEF DESCRIPTION OF THE DRAWINGS

FIG. 1 illustrates a perspective view of the container folded into the delivery shape and sealed according to an embodiment of the invention.

FIG. 2 illustrates a perspective view of the container of FIG. 1 as it would appear with its top open.

FIG. 3 illustrates a perspective view of an alternate embodiment of the container.

FIG. 4 illustrates a perspective view of the alternative embodiment of FIG. 3 with an open (unsealed) top.

FIG. 5 illustrates a perspective view of an alternative embodiment of the container.

FIG. 6 illustrates a flowchart of the method of the consumable goods delivery system.

### DETAILED DESCRIPTION OF THE INVENTION

Embodiments of the present invention are now explained. Although the disclosure is sufficient to enable those skilled in the art to practice the invention, the embodiments herein disclosed merely exemplify the invention, which may be embodied in other formats and/or designs. While the preferred embodiment has been described, the details may be changed without departing from the invention.

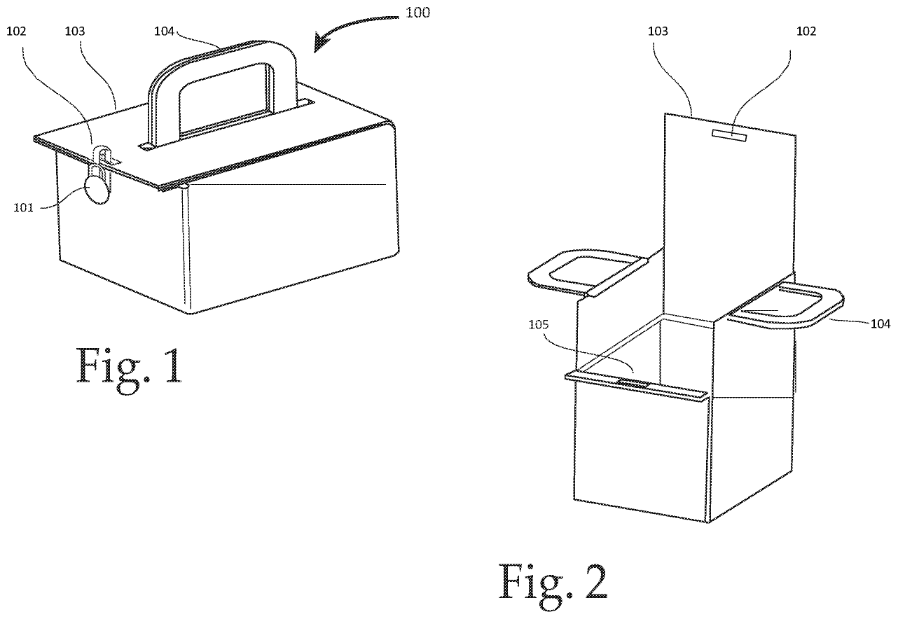

FIG. 1 illustrates an embodiment of the present invention. In FIG. 1, a containing device 100 for consumer goods, which is closed and locked with a barcoded seal 101.

The container 100 has a size and shape that can vary, depending on the type of consumer goods being carried therein. In some embodiments, the container 100 will be made of cardboard or a plastic composite the shape of a cuboid. In other embodiments, the container 100 will be a plastic bag or other receptacle having a flexible structure.

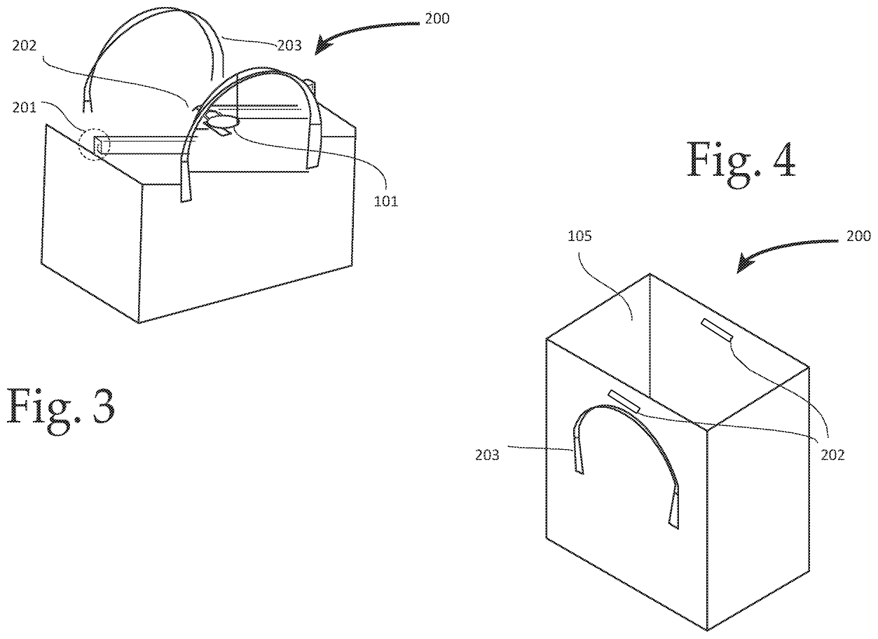

In some embodiments, the container 100 has a top, which can be opened by a lid 103, which may be flipped open (as illustrated in FIGS. 1 & 2) or unfolded (as illustrated FIGS. 3 & 4). In some embodiments, the container 100 can contain on or more handles 104. The handles 104 can be positioned to carry the container 100 from the top (as illustrated) or from either side (not illustrated).

Also in the invention, the container 100 includes antibacterial and/or antimicrobial properties. In some embodiments, the antibacterial and/or antimicrobial properties are impregnated into the cardboard or plastic (e.g., during a manufacturing operation). In other embodiments, the antibacterial and/or antimicrobial properties are subsequently added to the cardboard or plastic.

Furthermore, in the invention, the container 100 is sealed by a locking mechanism 101. This locking mechanism 101 is secured through an opening 102 on the lid 103 or other opening and contains a bar code that can be scanned for tracking purposes, to let the person who ordered goods know the location of the goods and the status of the delivery.

FIG. 2 illustrates the container 100 where the top is in an open position. In some embodiments, the interior of the container 100 includes an antibacterial and antimicrobial component 105. In some embodiments, the component 105 covers the entire interior of the container 100. For example, the component 105 covers each wall of the interior. In other embodiments, the component 105 covers a portion of the interior container 100.

FIG. 3 illustrates an alternative embodiment of the present invention. In this embodiment, the container 200 includes a top that is closed with a foldable closure 201, which is sealed by a barcoded seal 101. In this embodiment, instead of using a lid that can be flipped open and closed, the container 200 uses an opening 201 that can be opened and closed by unfolding and folding, respectively. The foldable closure 201 in this embodiment is sealed by the barcoded seal 101 being placed through an opening 202. In some embodiments (as illustrated), the container 200 includes handles 203 for the package to be carried with.

FIG. 4 illustrates the container 200, where the top is open, and the antibacterial and/or antimicrobial inner component 105 receives good thereon. This view also shows the opening 202 for the barcoded seal to be placed through and handles 203 for the package to be carried with.

FIG. 5 illustrates a flat alternative of the container 300, which can be used to hold flat items that should remain horizontal (e.g., pizza), locked with a barcoded seal 101.

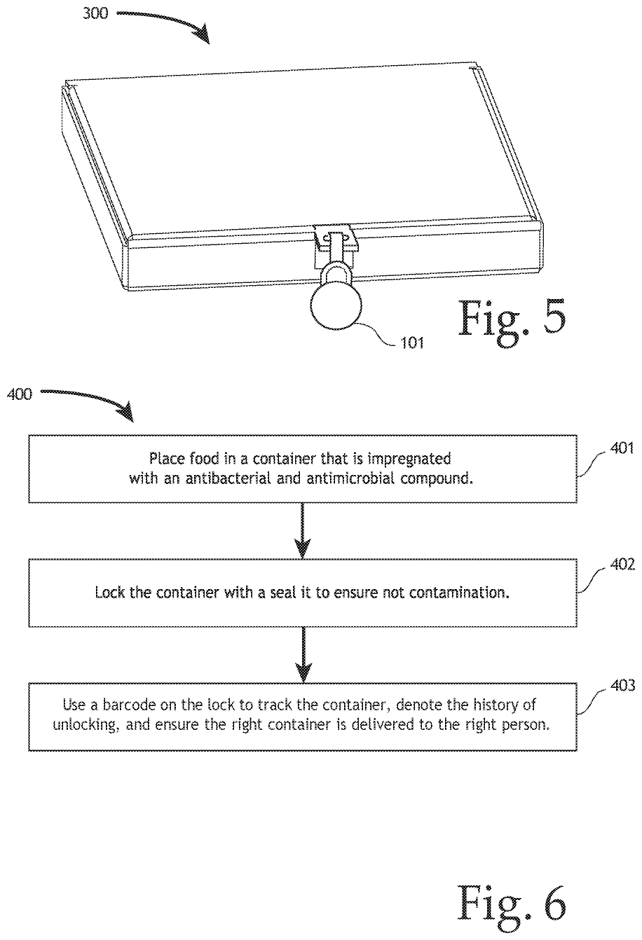

FIG. 6 illustrates the flowchart of the method of the delivery system 400.

The first step of this method consists of placing the goods in a container with an antibacterial and antimicrobial compound on its surface 401. In this step, the goods are placed inside the container, where they can be secured in an environment where it can remain contaminant free.

The second step of this system consists of locking the container (e.g., using a locking mechanism) with a seal to ensure it is not contaminated 402. This lock seals the goods in the container and helps better ensure that they will not be contaminated by whoever is delivering the container.

The final step of this method uses a barcode on the lock to track the container 403. In this step, the user is previously assigned a barcode when they complete their order and can track the history of their delivery through this barcode. Using this assigned barcode the consumer can determine exactly when their goods were placed in the container and sealed for delivery. This barcode also allows the consumer to track where their goods are in the delivery process.

Additionally, this barcode ensures the right container is delivered to the right person, by allowing whoever is handling the package the ability to determine who the container is going to. Specifically, this barcode is also used an input to unlock the locking mechanism securing the goods. This input information associating the customer with the container, can be uploaded manually by those who receive it or it can be uploaded automatically from a remote server.

What is claimed:

1. An apparatus for consumable goods delivery, comprising:
a container that is coated with an antibacterial and antimicrobial compound;
a locking mechanism configured to seal the container and prevent contamination;
and a barcode configured to receive input information at the locking mechanism that can be used to track the container, wherein the barcode is configured to communicate with an application that is used to track the container's location.

2. The apparatus as in claim 1, where the input information is entered manually by a user.

3. The apparatus as in claim 1, where input information is entered automatically from a remote server.

4. The apparatus as in claim 1, where the input information includes the current location of the said container, name of delivery person and/or status of the container.

5. The apparatus as in claim 1, where the container is constructed of cardboard.

6. The apparatus of claim 1, wherein the container is constructed of a plastic composite.

7. The apparatus of claim 1, wherein the container is a plastic bag.

8. The apparatus of claim 1, wherein the container is in the shape of a lock.

9. The apparatus of claim 1, wherein the application is on a mobile device.

10. The apparatus of claim 1, wherein the application is part of a commercially available third-party delivery system.

11. A method for transporting consumable goods, comprising:
placing goods in a container that is impregnated with an antibacterial and antimicrobial compound;
locking the container using a locking mechanism having a barcode configured to receive input information at the locking mechanism that can be used to track the container; and
communicating, using an application, the input information in order to track the container's location.

12. The method as in claim 11, where input information is entered manually by a user.

13. The method as in claim 11, where input information is entered automatically from a remote server.

14. The method as in claim 12, where the input information includes the current location of the said container, name of delivery person and/or status of the container.

15. The method of claim 11, wherein the container is constructed of cardboard.

16. The method of claim 11, wherein the container is constructed of a plastic composite.

17. The method of claim 11, wherein the container is constructed of a plastic bag.

18. The method of claim 12, wherein the application is on a mobile device and a part of a commercially available third-party delivery system.
